(19) United States
(12) Patent Application Publication
(10) Pub. No.: US 2017/0259210 A1
(43) Pub. Date: Sep. 14, 2017

(54) Solvent Separation System and Method

(71) Applicant: Asahi Kasei Kabushiki Kaisha, Tokyo (JP)

(72) Inventors: Junichi Kanemaru, Tokyo (JP); Takehiko Otoyo, Tokyo (JP); Mikihiko Nakamura, Tokyo (JP)

(73) Assignee: Asahi Kasei Kabushiki Kaisha, Tokyo (JP)

(21) Appl. No.: 15/504,861

(22) PCT Filed: Aug. 20, 2015
(86) PCT No.: PCT/JP2015/073414

§ 371 Date: Feb. 17, 2017

(30) Foreign Application Priority Data
Aug. 21, 2014 (JP) 2014-168839

(51) Int. Cl. B01D 61/00; C02F 1/44

(52) U.S. Cl. CPC B01D 61/002; C02F 1/445; C02F 2103/10

(57) ABSTRACT

The disclosure provides a solvent separation system and a solvent separation method using the solvent separation system.

### TECHNICAL FIELD

The present invention relates to a system and method for separating a solvent from a solution.

### BACKGROUND ART

The separation and recovery of solvents from solutions is widely carried out throughout various industries. The solvents to be separated contain solutes selected from inorganic compounds and organic compounds. Consequently, the recovered solvents frequently require a purification step. Purified solvents are then sold as solvents for use in process applications of the chemical industry or in various other applications.

Among these solvents, water is a typical solvent that contains various solutes in many cases and generally cannot be used directly as water. Thus, purification and regeneration are required to obtain usable water from this low-quality water.

Examples of water purification include desalination of seawater and purification of industrial wastewater. In the prior art, purification of water is carried out by energy-intensive methods requiring comparatively high temperature and pressure such as distillation or reverse osmosis. Thus, attention is being increasingly focused on forward osmosis technology (Patent Document 1).

Consequently, there is a desire for a process that enables purification and regeneration of water to be carried out efficiently.

### PRIOR ART DOCUMENTS

### Patent Documents

Patent Document 1: U.S. Patent Application Publication No. 2011/0272355

### DISCLOSURE OF THE INVENTION

### Problems to be Solved by the Invention

An object of the present invention is to provide a system and method for efficiently separating a solvent from a solution.

### Means for Solving the Problems

The inventors of the present invention conducted extensive studies to solve the aforementioned problems. As a result, it was found that, in a solvent purification system using a forward osmosis process, when a solvent is absorbed from an osmotic agent stream into which a solvent has migrated into a thermal phase change polymer stream, by controlling the respective temperatures of the liquid streams involved in this absorption so as to mutually have a specific relationship, solvent separation can be carried out more efficiently, thereby leading to completion of the present invention.

Namely, the present invention is as indicated below.

[1] A solvent separation system, comprising:

a first step for causing a feed stream a containing a solute and a solvent b to flow counter or parallel to an osmotic agent stream d through a semipermeable membrane o and causing the solvent b contained in the feed stream a to pass through the semipermeable membrane o and migrate into the osmotic agent stream d to obtain a flow e,

a second step for mixing the flow e containing the solvent b and the osmotic agent stream d with a thermal phase change polymer stream k to obtain a flow f, followed by separating the flow f containing the solvent b, the osmotic agent stream d and the thermal phase change polymer stream k into the osmotic agent stream d and a flow h containing the solvent b and the thermal phase change polymer stream k, and

a third step for heating the flow h followed by separating into the solvent b and the thermal phase change polymer stream k; wherein,

the second step simultaneously satisfies the following conditions (1) and (2):

(1) the relationship between a temperature Tk of the thermal phase change polymer stream k prior to mixing and a temperature Tf of the flow f after mixing is such that Tk−Tf=0.1° C. to 80° C., and

(2) the temperature Tf of the flow f after mixing is equal to or higher than the cloud point of the flow f.

[2] The system described in [1], wherein the relationship between a temperature Te of the flow e prior to mixing and the temperature Tf of the flow f after mixing is such that Te−Tf=0.1° C. to 80° C.

[3] The system described in [1] or [2], wherein the solvent b is water.

[4] The system described in any of [1] to [3], wherein the thermal phase change polymer contained in the thermal phase change polymer stream k is a copolymer of ethylene oxide and propylene oxide, and the ends thereof are either hydroxyl groups or one or more of the end hydroxyl groups is substituted with one or more types of groups selected from the group consisting of an alkyl group, phenyl group, allyl group and aryl group.

[5] The system described in any of [1] to [4], wherein the flow h containing the solvent b and the thermal phase change polymer stream k has a cloud point between 50° C. to 200° C.

[6] The system described in any of [1] to [5], wherein the osmotic agent contained in the osmotic agent stream d is one or more types selected from the group consisting of an inorganic base, organic base, salt, ionic polymer, ionic liquid, nonionic polymer and organic compound.

[7] The system described in any of [1] to [6], wherein the first step is carried out by a forward osmosis process.

[8] A solvent separation method, comprising: separating a solvent b from a feed stream a containing the solvent b and a solute selected from an inorganic compound and an organic compound using the system described in any of [1] to [7].

[9] A solvent separation system, comprising:

a first step for causing a feed stream a containing a solute and a solvent b to flow counter or parallel to an osmotic agent stream d through a semipermeable membrane o and causing the solvent b contained in the feed stream a to pass through the semipermeable membrane o and migrate into the osmotic agent stream d to obtain a flow e,

a second step for introducing the flow e, containing the solvent b and the osmotic agent stream d, and a thermal phase change polymer stream k into a counter flow extraction device S to cause the solvent b to migrate from the flow e into the thermal phase change polymer stream k followed by separating into the osmotic agent stream d and a flow h containing the solvent b and the thermal phase change polymer stream k, and

a third step for heating the flow h followed by separating into the solvent b and the thermal phase change polymer stream k.

[10] The system described in [9], wherein the relationship between a temperature Tk of the thermal phase change polymer stream k prior to mixing and a temperature Ts within the counter flow extraction device S in the second step is such that Tk−Ts=0.1° C. to 80° C.

[11] The system described in [9] or [10], wherein the relationship between a temperature Te of the flow e prior to mixing and the temperature Ts within the counter flow extraction device S in the second step is such that Te−Ts=0.1° C. to 80° C.

[12] The system described in any of [9] to [11], wherein the solvent b is water.

[13] The system described in any of [9] to [12], wherein the thermal phase change polymer contained in the thermal phase change polymer stream k is a copolymer of ethylene oxide and propylene oxide, and the ends thereof are either hydroxyl groups or one or more of the end hydroxyl groups is substituted with one or more types of groups selected from the group consisting of an alkyl group, phenyl group, allyl group and aryl group.

[14] The system described in any of [9] to [13], wherein the flow h containing the solvent b and the thermal phase change polymer stream k has a cloud point between 50° C. to 200° C.

[15] The system described in any of [9] to [14], wherein the osmotic agent contained in the osmotic agent stream d is one or more types selected from the group consisting of an inorganic base, organic base, salt, ionic polymer, ionic liquid, nonionic polymer and organic compound.

[16] The system described in any of [9] to [15], wherein the first step is carried out by a forward osmosis process.

[17] A solvent separation method, comprising: separating a solvent b from a feed stream a containing the solvent b and a solute selected from an inorganic compound and an organic compound using the system described in any of [9] to [16].

[18] A solvent separation device, provided with:

a unit A that has a structure in which a feed stream a and an osmotic agent stream d flow through a semipermeable membrane o in the form of counter flow or parallel flow, and has an inlet port for the feed stream a, a discharge port for a flow c obtained after the feed stream a has flown counter or parallel to the osmotic agent stream d through the semipermeable membrane o, an inlet port for the osmotic agent stream d, and a discharge port for a flow e obtained after the osmotic agent stream d has flown counter or parallel to the feed stream a through the semipermeable membrane o,

a counter flow extraction device S that has a structure in which the flow e is caused to flow counter to the thermal phase change polymer stream k and the solvent b in the flow e is extracted into the thermal phase change polymer stream k to obtain a flow h, and has an inlet port for the flow e and a discharge port for the flow e following extraction, an inlet port for the thermal phase change polymer stream k, a discharge port for the flow h, and a temperature control function, and

a unit B that has a heat exchanger q2 for heating the flow h and a separator B, wherein the separator B has a function that separates the flow h into the thermal phase change polymer stream k and the solvent b, and the separator B has an inlet port for the flow h, a discharge port for the thermal phase change polymer stream k, and a discharge port for the solvent b.

### Effects of the Invention

According to the present invention, a solvent can be efficiently separated from a solution.

The present invention can be preferably applied to applications such as desalination of seawater, purification of industrial wastewater, concentration of valuable resources, purification of injection water used during excavation of gas fields and oil fields for shell gas and oil, or treatment of produced water discharged accompanying excavation of gas fields and oil fields for shell gas and oil.

### BRIEF DESCRIPTION OF THE DRAWINGS

FIG. 1 is a conceptual diagram for explaining an overview of an embodiment of the system of the present invention.

FIG. 2 is a conceptual diagram for explaining an overview of another embodiment of the system of the present invention.

FIG. 3 is a conceptual diagram for explaining an example of a counter flow extraction device.

FIG. 4 shows an example of an embodiment of the system of the present invention.

FIG. 5 shows another example of an embodiment of the system of the present invention.

### BEST MODE FOR CARRYING OUT THE INVENTION

The following provides a specific explanation of details of the present invention.

An explanation is first provided of the relationships and functions of each element in the present invention.

A solute refers to a substance selected from inorganic compounds and organic compounds and preferably dissolves in a solvent b.

A feed stream a is a solution composed of the solvent b and a solute. The solvent b is a liquid. Examples of this feed stream a include seawater (in which, for example, sodium chloride is the solute and water is the solvent), industrial wastewater (in which, for example, various types of inorganic substances or organic substances are the solute and water is the solvent), liquids containing valuable resources (in which, for example, valuable resources such as a pharmaceutical or latex is the solute and water is the solvent), and produced water discharged from gas fields or oil fields (in which, for example, sodium chloride, oil or gas is the solute and water is the solvent). Examples of produced water include water containing salt that returns to the surface together with gas and oil produced after having subjected shale to hydraulic fracturing with a fracturing fluid. This produced water contains a high concentration of salt consisting mainly of sodium chloride.

The solvent b can be any inorganic solvent or organic solvent. The solvent b is present as a liquid in the feed stream a. There are many cases in which this solvent b is water.

An osmotic agent stream d is a liquid that has a higher osmotic pressure than the feed stream a and does not cause significant degeneration of a semipermeable membrane o. When contact is made between the feed stream a and the osmotic agent stream d through the semipermeable membrane o, the solvent b in the feed stream a migrates into the osmotic agent stream d by permeating the semipermeable membrane o. As a result of using the osmotic agent stream d in this manner, a forward osmosis process can be activated using the semipermeable membrane o.

A forward osmosis process refers to a process that causes two liquids having different osmotic pressures to make contact through the semipermeable membrane o, causing a solvent to migrate from the low osmotic pressure side to the high osmotic pressure side.

The aforementioned osmotic agent stream d is composed of an osmotic agent and a solvent thereof as necessary.

The osmotic agent can be, for example, an inorganic base, organic base, salt, ionic polymer, ionic liquid, nonionic polymer or organic compound.

The aforementioned inorganic base is, for example, sodium hydroxide, potassium hydroxide, calcium hydroxide or barium hydroxide.

The aforementioned organic base is, for example, tetraethylammonium hydroxide.

The aforementioned salt is, for example, sodium chloride, potassium chloride, ammonium chloride, sodium carbonate, sodium silicate, sodium sulfate, sodium sulfite, sodium phosphate, sodium formate, sodium succinate, sodium tartrate, sodium thiosulfate, lithium sulfate, ammonium sulfate, ammonium carbonate, ammonium carbamate, zinc sulfate, copper sulfate, iron sulfate, magnesium sulfate, aluminum sulfate, disodium hydrogen phosphate, monosodium dihydrogen phosphate, potassium phosphate, potassium carbonate, manganese sulfate or sodium citrate.

These inorganic bases, organic bases or salts are dissolved in a solvent in order to be used for the osmotic agent stream d. Water, for example, is preferably used for the solvent in this case.

The aforementioned ionic polymer is, for example, polyacrylic acid, low molecular weight sodium polyethylene sulfonate, sodium polymethyl acrylate or a copolymer thereof. These ionic polymers are dissolved in a solvent in order to be used for the osmotic agent stream d. Water, for example, is preferably used for the solvent in this case.

The aforementioned ionic liquid is a salt having a melting point of 100° C. or higher. More specifically, examples thereof include imidazolium salts, pyrrolidinium salts, piperidinium salts, pyridinium salts, morpholinium salts, ammonium salts, phosphonium salts and sulfonium salts. These ionic liquids are listed in, for example, the ionic fluid catalog published by Sigma-Aldrich (October 2012), and can be acquired as commercially available products. Specific examples thereof include butyltrimethylammonium bis(trifluoromethylsulfonyl)imide, 1-butyl-3-methylimidazoilum hexafluorophosphate, tetrabutylphosphonium methanesulfonate, 1-butyl-3-methylpyridinium bis(trifluoromethylsulfonyl)imide, 1-butyl-3-methylpyrrolidnium bis(trifluoromethylsulfonyl)imide, 1-butyl-3-methylpiperidinium bis(trifluoromethylsulfonyl)imide, triethylsulfonium bis(trifluoromethylsulfonyl)imide, tetrabutylphosphonium methanesulfonate and 4-ethyl-4-methylmorpholinium methyl carbonate. These ionic liquids can be used directly for the osmotic agent stream d or can be used after dissolving in a solvent (such as water).

The aforementioned nonionic polymer is, for example, dextran, polyethylene glycol, polyethylene oxide, polypropylene glycol, polypropylene oxide, or a copolymer of ethylene oxide and propylene oxide. The aforementioned polyethylene glycol, polypropylene glycol and copolymer of ethylene oxide and propylene oxide may have all or a portion of the hydrogen atoms thereof substituted with an alkyl group, phenyl group, allyl group or aryl group. These nonionic polymers are dissolved in a solvent in order to be used for the osmotic agent stream d. Water, for example, is preferably used for the solvent in this case.

Preferable examples of the aforementioned organic compounds include glycerol, ethylene glycol, diethylene glycol, triethanolamine, ethanol, propanol, acetone, diethyl ether, monoethers of ethylene glycol, monoethers of diethylene glycol, diethers of ethylene glycol, diethers of diethylene glycol, monoesters of ethylene glycol, monoesters of diethylene glycol, diesters of ethylene glycol, diesters of diethylene glycol and polysaccharides (such as sugar dimers or trimers). Examples of the aforementioned sugars include glucose and fructose. These organic compounds are dissolved in a solvent in order to be used for the osmotic agent stream d. Water, for example, is preferably used for the solvent in this case.

The osmotic agent in the present embodiment is preferably one or more types selected from the group consisting of ammonium sulfate, disodium hydrogen phosphate, sodium thiosulfate, sodium sulfite and magnesium sulfate. Ammonium sulfate and sodium thiosulfate are particularly preferable since they demonstrate high osmotic pressure when dissolved in water enabling a larger amount of solvent to migrate through the semipermeable membrane o. Sodium thiosulfate is particularly preferable due to the low reverse salt flux thereof.

These osmotic agents can be used alone or can be used after mixing. The osmotic agent stream d may also contain a trace amount of the polymer component contained in the thermal phase change polymer flow k to be subsequently described.

The solvent in the osmotic agent stream d is preferably the same type of solvent as the solvent b to be separated from the feed stream a. In the case the solvent b is water, the solvent in the osmotic agent stream d is preferably also water.

The concentration of the osmotic agent in the osmotic agent stream d is set so as to be higher than the osmotic pressure of the feed stream a. The osmotic pressure of the osmotic agent stream d may fluctuate provided it fluctuates within a range that is higher than the osmotic pressure of the feed stream a. Either of the following methods can be used to determine an osmotic pressure difference between two liquids.

(1) Case of biphasic separation after mixing the two liquids: The liquid that increases in volume following biphasic separation is determined to have higher osmotic pressure.

(2) Case of absence of biphasic separation after mixing the two liquids: The two liquids are allowed to contact through the semipermeable membrane o, and the liquid that has increased in volume after the passage of a certain amount of time is determined to have higher osmotic pressure. Although the certain amount of time at this time is dependent on the difference in osmotic pressure, it is generally from several minutes to several hours.

The semipermeable membrane o is a membrane having a function that allows the solvent b but not the solute to pass through. The blocking rate of the semipermeable membrane o with respect to sodium chloride is preferably 10% or more, more preferably 50% or more and even more preferably 98% or more. Examples of the form of the semipermeable membrane o include a hollow fiber, flat sheet membrane and spiral membrane.

Examples of the material that composes the semipermeable membrane o include materials used as reverse osmosis membranes in the prior art. Specific examples thereof include materials having a polyamide layer provided on the surface of a supporting membrane composed of cellulose acetate or polysulfone.

The flow e is a flow composed of the osmotic agent stream d and the solvent b that has passed through the semi-permeable membrane o from the feed stream a. In other words, the flow e is formed as a result of the solvent b migrating from the feed stream a into the osmotic agent stream d through the semipermeable membrane o.

A thermal phase change polymer refers to a polymer having properties that make the polymer compatible with the solvent b at a temperature equal to or lower than the cloud point, and properties that cause a polymer-rich phase and a solvent b-rich phase to undergo phase separation at a temperature above the cloud point. The thermal phase change polymer has a function that generates high osmotic pressure in the thermal phase change polymer stream k, and is the driving force behind the migration of the solvent b from the flow e to the thermal phase change polymer stream k.

Specific examples of this thermal phase change polymer include ethoxy hydroxyethyl cellulose, polyvinyl alcohol, poly-n-vinylcaprolactam, polyethylene glycol, polypropylene oxide, copolymers of ethylene oxide and propylene oxide, polyalkylene oxide, Triton® X-114, polyvinyl alcohol acetate, cellulose ethoxylate, acrylate-acrylic acid copolymer, phosphorous-containing polyolefins, cellulose ethers partially substituted with an ethyl group or methyl group, copolymers of vinyl alcohol and methyl vinyl ketone, copolymers of propylene glycol methacrylate and methyl methacrylate, (co)polymers of maleic acid diesters; and the polymer described in U.S. Patent Application Publication No. 2011/0272355.

The thermal phase change polymer is preferably a polymer that demonstrates high osmotic pressure in the thermal phase change polymer stream k and lowers the cloud point of the flow h. This thermal phase change polymer is preferably selected from among:

(1) polymers obtained by substituting one or more end hydroxyl groups of polyethylene glycol with one or more types of groups selected from the group consisting of an alkyl group, phenyl group, allyl group and aryl group, or

(2) polymers obtained by substituting one or more end hydroxyl groups of a copolymer of ethylene oxide and propylene oxide with one or more types of groups selected from the group consisting of an alkyl group, phenyl group, allyl group and aryl group, and

is more preferably selected from among:

(1) a polymer obtained by substituting one or more end hydroxyl groups of linear polyethylene glycol with an alkyl group, phenyl group, allyl group or aryl group, or

(2) a polymer obtained by substituting one or more end hydroxyl groups of a linear copolymer of ethylene oxide and propylene oxide with an alkyl group, phenyl group, allyl group or aryl group.

It is advantageous for the thermal phase change polymer stream k to have low viscosity in order to allow the solvent b to migrate from the flow e into the thermal phase change polymer stream k. Thus, it is preferable that the thermal phase change polymer contained in the thermal phase change polymer stream k have a low molecular weight from this viewpoint. On the other hand, it is advantageous for the molecular weight of the thermal phase change polymer contained in the flow h to be high in order for the solvent b to be obtained at high purity by the separator B to be subsequently described. When considering both of these requirements, the weight-average molecular weight of the thermal phase change polymer based on polystyrene as measured by gel permeation chromatography is preferably 300 to 10,000, more preferably 500 to 5,000 and even more preferably 500 to 1,500.

The thermal phase change polymer may be used directly for the thermal phase change polymer stream k or may be used for the thermal phase change polymer stream k in the form of a solution in which it is dissolved in a suitable solvent. In the case the thermal phase change polymer stream k contains a solvent, the solvent is preferably the same type of solvent as the solvent b to be separated from the feed stream a.

The concentration of the thermal phase change polymer in the thermal phase change polymer stream k can be suitably set according to the value of a desired osmotic pressure. The osmotic pressure of the thermal phase change polymer stream k is higher than the osmotic pressure of the flow d and may fluctuate provided it is within that range. The thermal phase change polymer stream k may contain a trace amount of the aforementioned osmotic agent.

The flow f refers to a mixture of the flow e and the thermal phase change polymer stream k. Thus, the flow f contains the solvent b, the osmotic agent stream d and the thermal phase change polymer stream k. Solvents thereof are contained in the flow f in the case the thermal phase change polymer stream k contains a solvent, the osmotic agent stream d contains a solvent or both streams thereof contain a solvent.

The flow h refers to a flow composed of the solvent b that has migrated from the flow e and the thermal phase change polymer stream k. This flow h may contain a trace amount of an osmotic agent. This flow h is in a state in which the solvent b and the thermal phase change polymer stream k are dissolved in a single phase.

The following provides an explanation of the solvent separation system of the present invention with reference to the drawings as necessary.

The solvent separation system of the present invention is a solvent separation system comprising:

a first step for causing the feed stream a containing a solute and the solvent b to flow counter or parallel to the osmotic agent stream d through the semipermeable membrane o and cause the solvent b contained in the feed stream a to pass through the semipermeable membrane o and migrate into the osmotic agent stream d to obtain the flow e,

a second step for mixing the flow e containing the solvent b and the osmotic agent stream d with the thermal phase change polymer stream k at a mixing point α to obtain the flow f, followed by separating the flow f containing the solvent b, the osmotic agent stream d and the thermal phase change polymer stream k into the osmotic agent stream d and the flow h containing the solvent b and the thermal phase change polymer stream k, and

a third step for heating the flow h followed by separating into the solvent b and the thermal phase change polymer stream k, wherein

the second step simultaneously satisfies the following conditions (1) and (2):

(1) the relationship between the temperature Tk of the thermal phase change polymer stream k prior to mixing and the temperature Tf of the flow f after mixing is such that Tk−Tf=0.1° C. to 80° C., and

(2) the temperature Tf of the flow f after mixing is equal to or higher than the cloud point of the flow f. In the above description, the relationship between the temperature Te of the flow e prior to mixing and the temperature Tf of the flow f after mixing is preferably such that Te−Tf=0.1° C. to 80° C.

The temperature Tk of the thermal phase change polymer stream k refers to the temperature of the thermal phase change polymer stream k at a location near the mixing point α where the thermal phase change polymer stream k merges with the flow e.

The temperature Tf of the flow f refers to the temperature of the flow f formed as a result of the thermal phase change polymer stream k merging with the flow e.

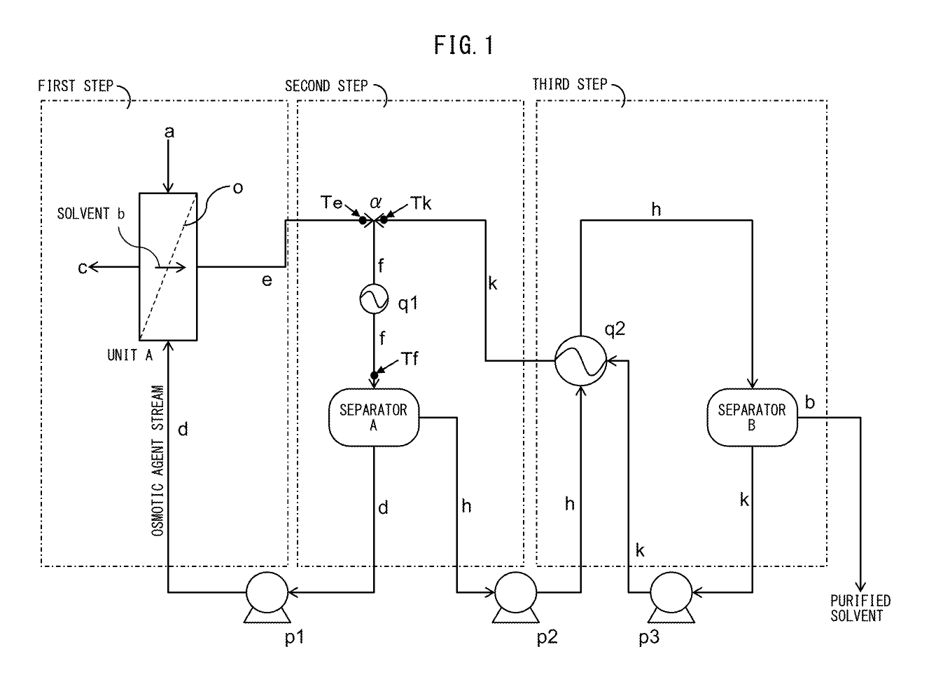

FIG. 1 is a conceptual diagram for explaining an overview of an embodiment of the solvent separation system of the present invention.

The first step is a step for causing the feed stream a containing a solute and the solvent b to flow counter or parallel to the osmotic agent stream d through the semipermeable membrane o and cause the solvent b contained in the feed stream a to pass through the semipermeable membrane o and migrate into the osmotic agent stream d to obtain the flow e. In this first step, a unit A is used that has been designed so that the two flows can flow counter or parallel to each other through the semipermeable membrane o.

In the first step, the feed stream a flows through the semipermeable membrane o counter or parallel to the osmotic agent stream d in the unit A. As a result, the solvent b in the feed stream a migrates to the osmotic agent stream d through the semipermeable membrane o. This migration of the solvent b uses the semipermeable membrane o as a forward osmosis membrane and is the result of a forward osmosis process, and is preferable from the viewpoint of enabling solvent to be separated efficiently while consuming only a small amount of energy.

The osmotic agent stream d becomes the flow e as a result the solvent migrating thereto and being mixed therein, and is then discharged from the unit A.

The second step is a step for mixing the flow e containing the solvent b and the osmotic agent stream d with the thermal phase change polymer stream k at a mixing point α to obtain the flow f, followed by separating the flow f containing the solvent b, the osmotic agent stream d and the thermal phase change polymer stream k into the osmotic agent stream d and the flow h containing the solvent b and the thermal phase change polymer stream k.

In a certain embodiment of the present invention, a cooling device q1 and a separator A are used in this second step.

In the flow f, migration of the solvent b from the flow e into the thermal phase change polymer stream k occurs due to mixing of the flow e and the thermal phase change polymer stream k. The use of the cooling device q1 at an intermediate location of this flow f makes it possible to promote migration of the solvent b into the thermal phase change polymer stream k. A chiller or heat exchanger, for example, can be used for the cooling device q1.

Any separator may be used for the separator A provided it has a function that separates the flow f into the thermal phase change polymer stream k containing the solvent b (namely, flow h) and the flow e from which the solvent b is released (namely, osmotic agent stream d). For example, the separator A can be a device having a suitable means for carrying out such separation such as a centrifugal separation device, gravitational sedimentation device, coalescer or hydrocyclone.

In this second step, the relationship between the temperature Tk and the temperature Tf is such that Tk−Tf=0.1° C. to 80° C., and the temperature Tf of the flow f after mixing is equal to higher than the cloud point of the flow f. More preferably, the relationship between the temperature Te and the temperature Tf is such that Te−Tf=0.1° C. to 80° C. The temperature Tk is the temperature of the aforementioned thermal phase change polymer stream k at a location immediately before the mixing point α where the thermal phase change polymer stream k and flow e converge. The temperature Tf is the temperature of the aforementioned flow f at a location immediately before where the flow f enters the separator A. The temperature Te is the temperature of the flow e at a location immediately before the mixing point α where the flow e converges with the thermal phase change polymer stream k.

The temperature Tf of the flow f is a temperature that is higher than the cloud point of the flow f. The cloud point of the flow f as referred to here is the temperature at which clouding begins to occur when the flow f is heated from a low temperature at which it is uniformly dissolved. Thus, at least the flow f that enters the separator A is a mixed flow composed of two phases consisting of the flow e and the thermal phase change polymer stream k.

The temperature Tf is preferably as low as possible within a range that does not go below the cloud point of the flow f in order to promote migration of the solvent b from the flow e into the thermal phase change polymer stream k. On the other hand, a larger temperature difference between Tk and Tf is more disadvantageous in terms of energy consumption. Thus, it is necessary for Tk−Tf to be within the range of 0.1° C. to 80° C. The value of Tk−Tf is preferably 0.1° C. to 50° C. and more preferably 0.1° C. to 30° C. However, the requirement that Tf be equal to or higher than the cloud point of the flow f must always be satisfied.

As was described above, the temperature Tf is preferably as low as possible within a range that does not go below the cloud point of the flow f in order to promote migration of the solvent b from the flow e to the thermal phase change polymer stream k. On the other hand, a larger temperature difference between Te and Tf is more disadvantageous in terms of energy consumption. Thus, Te−Tf is preferably 0.1° C. to 80° C. The value of Te−Tf is more preferably 0.1° C. to 50° C. and even more preferably 0.1° C. to 30° C. However, the requirement that Tf be equal to or greater than the cloud point of the flow f must always be satisfied.

The Tk, Tf and Te in this embodiment are specifically measured at the locations of the black circles indicated with arrows denoted as Tk, Tf and Te, respectively, in the second step of FIG. 1.

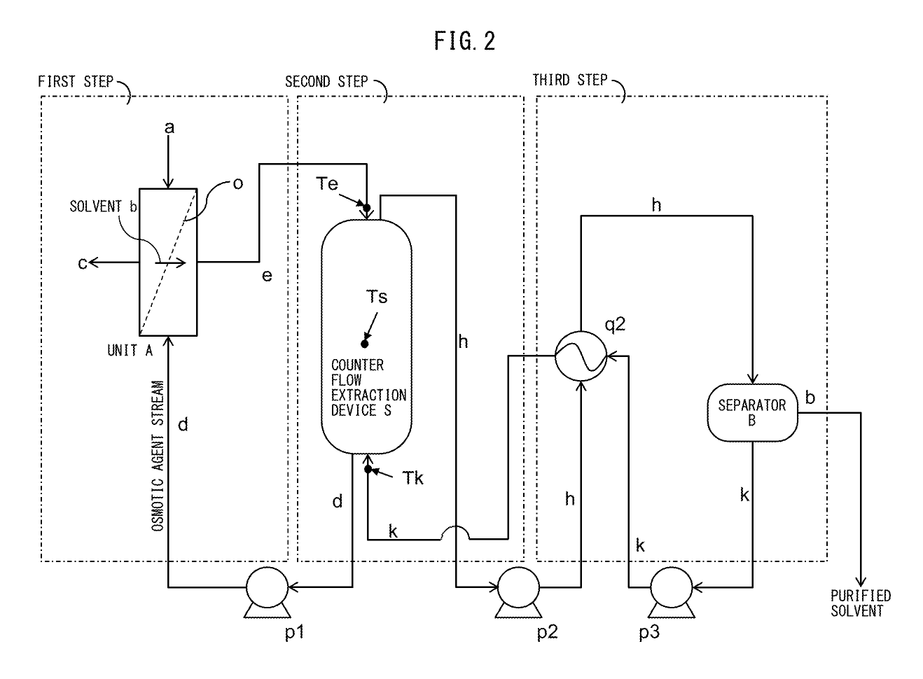

In another embodiment of the present invention, a counter flow extraction device S is used instead of the cooling device q1 and the separator A in this second step. FIG. 2 shows a conceptual diagram for explaining an overview of the solvent separation system of the present invention in the case of using the counter flow extraction device S.

The following provides an explanation of the counter flow extraction device S.

It is necessary to mix and then separate the flow e and the thermal phase change polymer stream k in order to allow the solvent b to migrate from the flow e into the thermal phase change polymer stream k.

The counter flow extraction device S refers to a device that allows the flow e and the thermal phase change polymer stream k to make counter flow contact. As a result of making counter flow contact, mixing and separation can be carried out efficiently and the solvent b can be allowed to efficiently migrate from the flow e into the thermal phase change polymer stream k. The flow e and the thermal phase change polymer stream k are injected and allowed to respectively make counter flow contact such that the flow composed of liquid having a comparatively high specific gravity is injected from the upper portion of the counter flow extraction device S while the flow composed of liquid having a comparatively low specific gravity is injected from the lower portion. For example, in the case of using a concentrated inorganic salt solution for the osmotic agent stream d and a polymer solution for the thermal phase change polymer stream k, the osmotic agent stream d is preferably injected from the upper portion since this stream normally has a high specific gravity, while the thermal phase change polymer stream k is preferably injected from the lower portion.

Examples of the counter flow extraction device S include a packed column, spray column, sieve tray and rotating disc column. A specific example thereof is the device explained and exemplified in the 7th Edition of the Chemical Engineering Handbook (edited by the Society of Chemical Engineers, Japan and published by Maruzen Publishing Co., Ltd., ISBN978-4-621-08388-8). The counter flow extraction device S preferably has a temperature control function.

The counter flow extraction device S in the present invention does not require standing or centrifugal separation in order to carry out separation provided the required column height can be ensured. Consequently, it is particularly advantageous for extracting between liquids that are difficult to separate and also makes it possible for the solvent separation system to save on space.

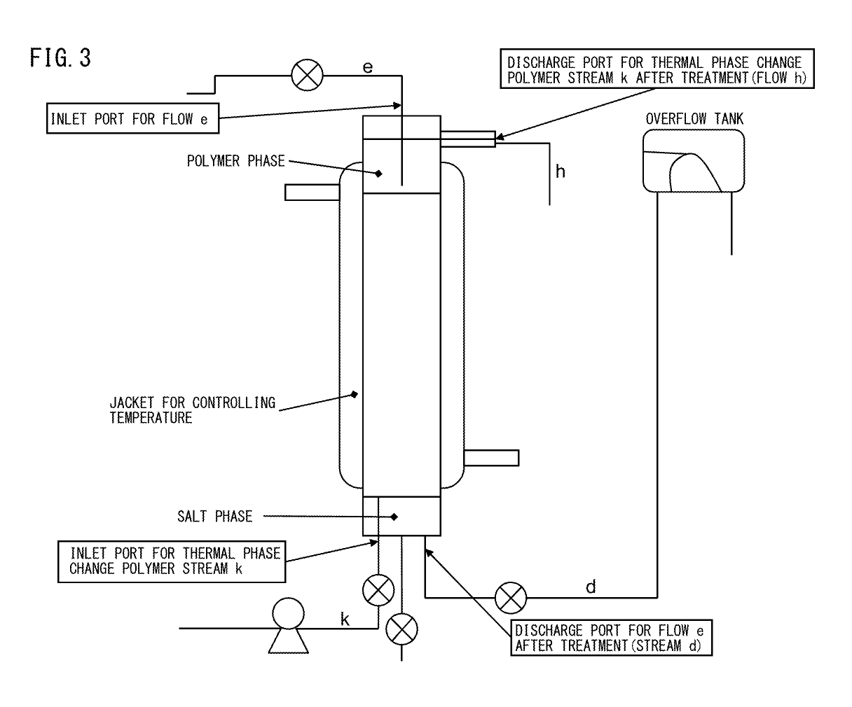

An overview of an example of a counter flow extraction device S preferably used in the present invention is shown in FIG. 3.

The temperature relationships of each component in the second step in the case of using the counter flow extraction device S are the same as those in the previously described case. However, the temperature Ts inside the counter flow extraction device S is used instead of the temperature Tf of the flow f. Namely, in the second step, the relationship between the temperature Tk of the thermal phase change polymer stream k prior to mixing and the temperature Ts inside the counter flow extraction device S is such that Tk−Ts=0.1° C. to 80° C., and more preferably the relationship between the temperature Te of the flow e prior to mixing and the temperature Ts inside the counter flow extraction device S is such that Te−Ts=0.1° C. to 80° C. The value of Tk−Ts is preferably 0.1° C. to 50° C. and more preferably 0.1° C. to 30° C. The value of Te−Ts is more preferably 0.1° C. to 50° C. and even more preferably 0.1° C. to 30° C. The temperature Ts inside the counter flow extraction device S is always required to satisfy the requirement that the temperature Ts be equal to or higher than the cloud point of the liquid resulting from mixing the flow e and the thermal phase change polymer stream k at a 1:1 ratio.

In this embodiment, Tk, Ts and Te are specifically measured at the locations of the black circles indicated with arrows denoted as Tk, Ts and Te, respectively, in the second step of FIG. 2.

The third step of the solvent separation system of the present invention is a step for heating the flow h followed by separating into the solvent b and the thermal phase change polymer stream k. This third step is the same for both the system shown in FIG. 1 and the system shown in FIG. 2.

This third step can be carried out using, for example, a heat exchanger q2 and a separator B.

The heat exchanger q2 is a heat exchanger that is used as necessary, and is a device that allows heat to be transferred from the thermal phase change polymer stream k at a higher temperature to the flow h at a lower temperature.

The separator B refers to a device that allows the solvent b to migrate from the flow h, and is operated at a temperature equal to or higher than the cloud point of the flow h. The cloud point of the flow h refers to the temperature at which clouding begins to occur when the flow h is heated to a higher temperature from a low temperature at which it is uniformly dissolved. Thus, the flow h is separated into the solvent b and a thermal phase change polymer-rich phase in the aforementioned separator B. At this time, the operational temperature of the separator B is preferably set so that the concentration of the thermal phase change polymer in the polymer-rich phase following separation is equal to the concentration of the thermal phase change polymer of the thermal phase change polymer stream k.

Examples of the separator B include a device having one or more types of means selected from a centrifugal separation device, gravitational sedimentation device, coalescer, hydrocyclone and filtering unit (such as that carrying out solid-liquid separation or oil-water separation).

There are cases in which the solvent b separated by the separator B contains trace amounts of impurities. Thus, depending on the case, an additional purification means can be added for the solvent b discharged from the separator B. Examples of additional purification means include nanofiltration, reverse osmosis filtration, ultrafiltration, microfiltration, ion exchange resin, activated charcoal and various types of adsorbent materials. Concentrated liquid obtained by nanofiltration or other form of membrane filtration from this purification means may be returned to the first step, second step or third step, or may be discarded.

Although the cloud point of the flow h is preferably sufficiently high in comparison with room temperature, an excessively high cloud point is disadvantageous in terms of energy consumption. Thus, the cloud point of the thermal phase change polymer stream h is preferably 40° C. to 200° C., more preferably 50° C. to 180° C., and even more preferably 50° C. to 150° C.

The following provides an explanation of another embodiment of the system of the present invention with reference to additional drawings.

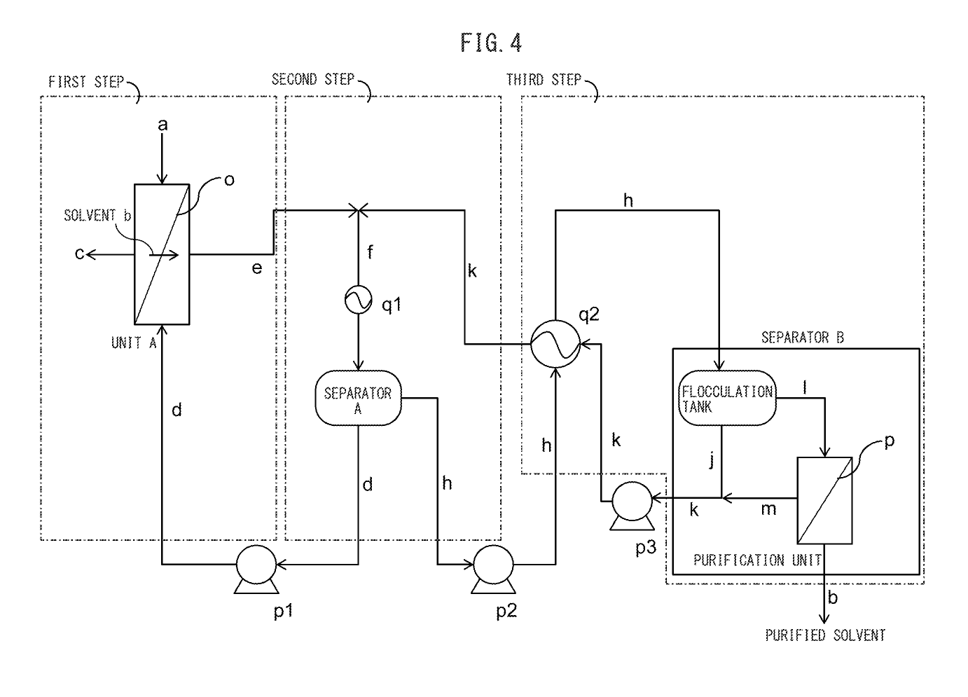

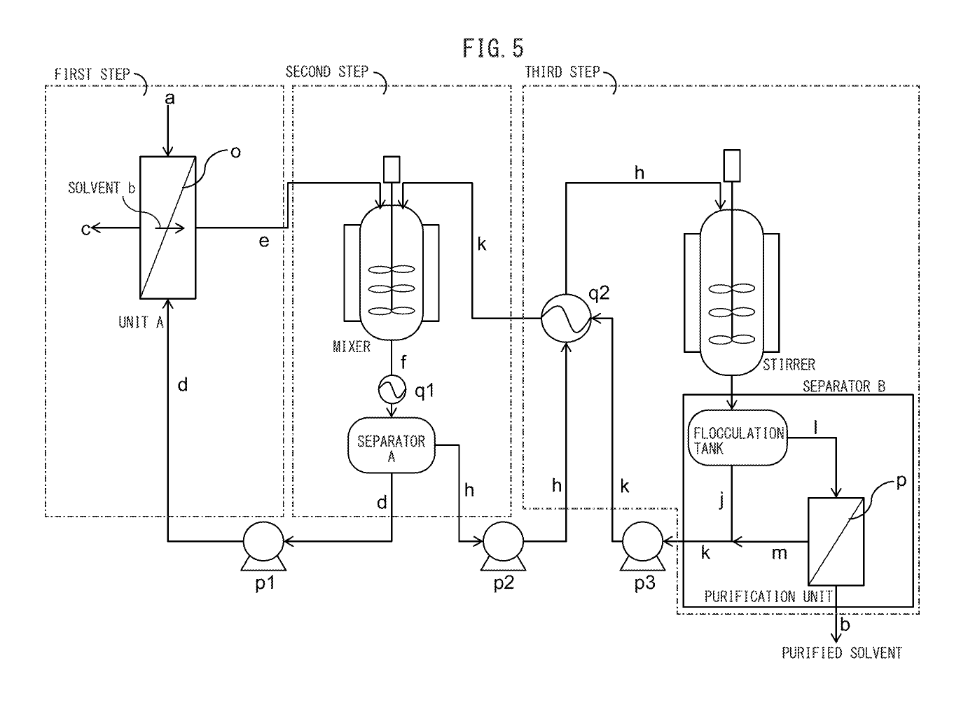

Examples of systems of other embodiments of the present invention are shown in FIGS. 4 and 5.

The system shown in FIG. 4 is the same as the system shown in the aforementioned FIG. 1 with the exception of using a compound unit composed of a flocculation tank and a filtering unit having a semi-permeable membrane p.

This flocculation tank has a function that separates the flow h into a thermal phase change polymer-rich stream j and a solvent-rich stream 1 using the principle of gravitational sedimentation or centrifugal separation. The solvent-rich stream 1 is introduced into a purification unit. The solvent b in the solvent-rich stream 1 is purified by this purification unit.

The purification unit shown in FIG. 4 is equipped with a semi-permeable membrane p that has a function that allows permeation of solvent but does not allow permeation of solute. Solvent purification carried out by the purification unit can be carried out by, for example, a reverse osmosis membrane method, microfiltration method, ultrafiltration method, nanofiltration method, pervaporation method, perdistillation method or membrane distillation, and these methods can be used alone or in combination.

A flow m, in which the thermal phase change polymer has been concentrated following migration and removal of solvent, is reused with the stream j as the thermal phase change polymer stream k.

As a result of configuring the separator B in the third step in the form of a compound unit in this manner, the purity of the ultimately obtained purified solvent can be further improved.

The system shown in FIG. 5 is the same as the system shown in the aforementioned FIG. 4 with the exception of respectively installing a mixer for mixing the flow e with the thermal phase change polymer stream k in the second step and a stirrer used prior to separation of the flow h in the third step.

The installation of the aforementioned mixer in the second step promotes mixing of the flow e and the stream k.

The installation of the aforementioned stirrer in the third step offers the advantage of allowing the third step to proceed smoothly when the flow h is separated into two phases consisting of the thermal phase change polymer-rich stream j and the solvent-rich stream 1.

In the systems shown in FIGS. 4 and 5, an aspect using a counter flow extraction device for the separation means of the second step can also be preferably employed as a specific embodiment of the present invention.

Reference symbols p1, p2 and p3 shown in FIGS. 1 to 5 referred to during the aforementioned explanations are each pumps for feeding liquids.

As has been previously described, the solvent b can be recovered from the feed stream a at high purity as a result of going through the first step, second step and third step of the present invention.

### EXAMPLES

The following provides an explanation of the present invention based on examples thereof.

Number-average molecular weight as referred to in the following examples and comparative examples is the number-average molecular weight based on polystyrene as measured by gel permeation chromatography (GPC) using the device indicated below.

Device: Tosoh Corp., HLC-8220GPC

Columns: Tosoh Corp., TSKgel G1000HXL×1 column, TSKgel G2000HXL×1 column and TSKgel G3000HXL×1 column

Carrier: Wako Pure Chemical Industries, Ltd., special grade tetrahydrofuran

Detection method: Differential refractometer

Carrier flow rate: 1.0 mL/min

Calibration curve: Tosoh Corp., TSK standard polystyrenes

Column chamber internal temperature: 40° C.

Sample concentration: 0.05% by weight to 0.1% by weight

Sample injection volume: 50 μL

A thermocouple (k type) was installed at the corresponding location for each temperature and the temperature displayed by the LT370 manufactured by Chino Corp. connected to the thermocouple was read therefrom.

The primary effect of the present invention is to increase the amount of solvent that migrates from the flow e to the flow h by controlling temperature in the second step. Thus, the following Examples 1 to 16 and Comparative Examples 1 to 4 were investigated while focusing on the migration of solvent (water) in the second step.

### Examples 1 to 4 and Comparative Example 1

Examples 1 to 4 and Comparative Example 1 were carried out using the system shown in FIG. 1.

Water was used for the solvent b, ammonium sulfate was used for the osmosis agent, and Epan® 450 (copolymer of polyethylene oxide and polypropylene oxide, number-average molecular weight: 2,400, DKS Co., Ltd.) was used for the thermal phase change polymer. The concentration of ammonium sulfate in the osmotic agent stream d was 10% by weight and the concentration of Epan 450 in the thermal phase change polymer stream k was 75% by weight.

A forward osmosis unit was used for the unit A in the first step, a centrifugal separation unit was used for the separator A in the second step, and a purification unit composed of a flocculation tank for gravitational sedimentation and reverse osmosis membrane was used for the separator B in the third step. Seawater was used for the feed stream a and the feed rate thereof was 120 L/min. The flow rate of the osmotic agent stream d was 120 L/min and the flow rate of the thermal phase change polymer stream k was 120 L/min.

The composition of the flow e, the composition of the thermal phase change polymer stream k, and the composition of the flow h following separation with the separator A when the temperature Te of the flow e, the temperature Tk of the thermal phase change polymer stream k and the temperature Tf of the flow f were respectively adjusted as shown in Table 1 were investigated and the amount of water migrating from the flow e to the flow h (difference between the amount of water in the flow h and the amount of water in the thermal phase change polymer stream k) was confirmed. Te, Tk and Tf were measured at the locations of the black circles specified by the arrows denoted with Te, Tk and Tf, respectively, in the second step shown in FIG. 1.

The composition of the flow e in Examples 1 to 4 and Comparative Example 1 consisted of 28.0 g of water and 2.0 g of ammonium sulfate based on a total amount of 30.0 g. Other values are shown in Table 1.

TABLE 1

| | | | | | | | | | | Comp. | |
|---|---|---|---|---|---|---|---|---|---|---|---|
| | | Example 1 | | Example 2 | | Example 3 | | Example 4 | | Ex. 1 | |
| Temperature | Te | 25° C. | | 25° C. | | 25° C. | | 25° C. | | 25° C. | |
| | Tk | 30° C. | | 30° C. | | 30° C. | | 40° C. | | 25° C. | |
| | Tf | 5° C. | | 10° C. | | 20° C. | | 7° C. | | 40° C. | |
| | Te − Tf | 20° C. | | 15° C. | | 5° C. | | 18° C. | | −15° C. | |
| | Tk − Tf | 25° C. | | 20° C. | | 10° C. | | 33° C. | | −15° C. | |
| Cloud point | Flow f | <0° C. | | <0° C. | | <0° C. | | <0° C. | | <0° C. | |
| | Flow k | 90° C. | | 90° C. | | 90° C. | | 90° C. | | 90° C. | |
| | Flow h | 71° C. | | 73° C. | | 75° C. | | 72° C. | | 81° C. | |
| Composition | Flow | k | h | k | h | k | h | k | h | k | h |
| | Total | 30.0 | 49.2 | 30.0 | 47.6 | 30.0 | 46.1 | 30.0 | 48.4 | 30.0 | 40.0 |
| | amount. (g) | | | | | | | | | | |
| | Water (g) | 7.5 | 26.7 | 7.5 | 25.1 | 7.5 | 23.6 | 7.5 | 25.9 | 7.5 | 17.5 |
| | Polymer (g) | 22.5 | 22.5 | 22.5 | 22.5 | 22.5 | 22.5 | 22.5 | 22.5 | 22.5 | 22.5 |

| | | | | | |
|---|---|---|---|---|---|
| Water migration | 19.2 | 17.6 | 16.1 | 18.4 | 10 |
| from e to h (g) | | | | | |

### Examples 5 to 8 and Comparative Example 2

Examples 5 to 8 and Comparative Example 2 were carried out using the same method as Examples 1 to 4 and Comparative Example 1 with the exception of using sodium thiosulfate and sodium sulfite as osmotic agents and making the concentration of sodium thiosulfate to be 10% by weight and the concentration of sodium sulfite to be 0.5% by weight in the osmotic agent stream d, and the amount of water migrating from the flow e to the flow h was confirmed when adjusting the temperature Te of the flow e, temperature Tk of the thermal phase change polymer stream k and temperature Tf of the flow f as described in Table 2.

The composition of the flow e in Examples 5 to 8 and Comparative Example 2 consisted of 28.0 g of water and a total of 2.0 g of sodium thiosulfate and sodium sulfite based on a total amount of 30.0 g. Other values are shown in Table 2.

TABLE 2

| | | | | | | | | | | Comp. | |
|---|---|---|---|---|---|---|---|---|---|---|---|
| | | Example 5 | | Example 6 | | Example 7 | | Example 8 | | Ex. 2 | |
| Temperature | Te | 25° C. | | 25° C. | | 25° C. | | 25° C. | | 25° C. | |
| | Tk | 30° C. | | 30° C. | | 30° C. | | 40° C. | | 25° C. | |
| | Mixer | 28° C. | | 28° C. | | 28° C. | | 33° C. | | 25° C. | |
| | Tf | 5° C. | | 10° C. | | 20° C. | | 7° C. | | 40° C. | |
| | Te − Tf | 20° C. | | 15° C. | | 5° C | | 18° C. | | −15° C. | |
| | Tk − Tf | 25° C. | | 20° C. | | 10° C. | | 33° C. | | −15° C. | |
| Cloud point | Flow f | <0° C. | | <0° C. | | <0° C. | | <0° C. | | <0° C. | |
| | Flow k | 90° C. | | 90° C. | | 90° C. | | 90° C. | | 90° C. | |
| | Flow h | 70° C. | | 71° C. | | 73° C. | | 70° C. | | 80° C. | |
| Composition | Flow | k | h | k | h | k | h | k | h | k | h |
| | Total | 30.0 | 50.1 | 30.0 | 49.2 | 30.0 | 47.8 | 30.0 | 49.8 | 30.0 | 41.4 |
| | amount. (g) | | | | | | | | | | |
| | Water (g) | 7.5 | 27.6 | 7.5 | 26.7 | 7.5 | 25.3 | 7.5 | 27.3 | 7.5 | 18.9 |
| | Polymer (g) | 22.5 | 22.5 | 22.5 | 22.5 | 22.5 | 22.5 | 22.5 | 22.5 | 22.5 | 22.5 |

| | | | | | |
|---|---|---|---|---|---|
| Water migration | 20.1 | 19.2 | 17.8 | 19.8 | 11.4 |
| from e to h (g) | | | | | |

### Examples 9 to 12 and Comparative Example 3

Examples 9 to 12 and Comparative Example 3 were carried out using the system shown in FIG. 2.

Water was used for the solvent b, ammonium sulfate was used for the osmotic agent, and Pepol® AH-0673A (copolymer of ethylene oxide and propylene oxide in which the hydroxyl group on one end is substituted with an allyl group, number-average molecular weight: 2,000, Toho Chemical Industry Co., Ltd.) was used for the thermal phase change polymer. The concentration of ammonium sulfate in the osmotic agent stream d was 30% by weight and the concentration of Pepol AH-0673A in the thermal phase change polymer stream k was 80% by weight.

A forward osmosis unit was used for unit A in the first step, a cylindrical packed column made of polyvinyl chloride, having a tower diameter of 5 cm and a packing tower height of 3.5 m, and using a packing material having an outer diameter of 10 mm, inner diameter of 8 mm and length of 10 mm for the packing material, was used for the counter flow extraction device in the second step. A purification unit composed of a flocculation tank for gravitational sedimentation and a reverse osmosis membrane was used for the separator B of the third step. Seawater was used for the feed stream a and the feed rate was 20 mL/min. The flow rate of the osmotic agent stream d was 20 mL/min and the flow rate of the thermal phase change polymer stream k was 20 mL/min.

The composition of the flow e, the composition of the thermal phase change polymer stream k, and the composition of the flow h following separation with the counter flow extraction device when the temperature Te of the flow e, temperature Tk of the thermal phase change polymer stream k and the temperature Ts within the counter flow extraction device S were respectively adjusted as shown in Table 3 were investigated, and the amount of water migrating from the flow e to the flow h (difference between the amount of water in the flow h and the amount of water in the thermal phase change polymer stream k) was confirmed. Te, Tk and Ts were measured at the locations of the black circles specified by the arrows denoted with Te, Tk and Ts, respectively, in the second step shown in FIG. 2.

The composition of the flow e in Examples 9 to 12 and Comparative Example 3 consisted of 22.8 g of water and 7.2 g of ammonium sulfate based on a total amount of 30.0 g. Other values are shown in Table 3.

TABLE 3

| | | | | | | | | | | Comp. | |
|---|---|---|---|---|---|---|---|---|---|---|---|
| | | Example 9 | | Example 10 | | Example 11 | | Example 12 | | Ex. 3 | |
| Temperature | Te | 25° C. | | 25° C. | | 25° C. | | 40° C. | | 25° C. | |
| | Tk | 30° C. | | 30° C. | | 30° C. | | 40° C. | | 25° C. | |
| | Ts | 20° C. | | 15° C. | | 22° C. | | 37° C. | | 30° C. | |
| | Te − Ts | 5° C. | | 10° C. | | 3° C. | | 3° C. | | −10° C. | |
| | Tk − Ts | 10° C. | | 15° C. | | 8° C. | | 3° C. | | −10° C. | |
| Cloud point | Flow f | <0° C. | | <0° C. | | <0° C. | | <0° C. | | <0° C. | |
| | Flow k | 135° C. | | 135° C. | | 135° C. | | 135° C. | | 135° C. | |
| | Flow h | 98° C. | | 98° C. | | 99° C. | | 100° C. | | 111° C. | |
| Composition | Flow | k | h | k | h | k | h | k | h | k | h |
| | Total | 30.0 | 34.5 | 30.0 | 34.7 | 30.0 | 34.2 | 30.0 | 33.5 | 30.0 | 31.3 |
| | amount. (g) | | | | | | | | | | |
| | Water (g) | 6.0 | 10.5 | 6.0 | 10.7 | 6.0 | 10.2 | 6.0 | 9.5 | 6.0 | 7.3 |
| | Polymer (g) | 24.0 | 24.0 | 24.0 | 24.0 | 24.0 | 24.0 | 24.0 | 24.0 | 24.0 | 24.0 |

| | | | | | |
|---|---|---|---|---|---|
| Water migration | 4.5 | 4.7 | 4.2 | 3.5 | 1.3 |
| from e to h (g) | | | | | |

### Examples 13 to 16 and Comparative Example 4

Examples 13 to 16 and Comparative Example 4 were carried out using the same method as Examples 9 to 12 and Comparative Example 3 with the exception of using sodium thiosulfate and sodium sulfite as osmotic agents and using Uniox® AA-800 (polyethylene oxide having both end hydroxyl groups substituted with allyl groups, number-average molecular weight: 800, NOF Corp.) for the thermal phase change polymer, and making the concentration of the sodium thiosulfate 38% by weight and the concentration of sodium sulfite 0.5% by weight in the osmotic agent stream d, and making the concentration of Uniox AA-800 70% by weigh in the thermal phase change polymer stream k, and the amount of water migrating from the flow e to the flow h was confirmed when the temperature Te of the flow e, temperature Tk of the thermal phase change polymer stream k and the temperature Ts within the counter flow extraction device S were respectively adjusted as shown in Table 4.

The composition of the flow e in Examples 13 to 16 and Comparative Example 4 consisted of 22.8 g of water and 7.2 g of ammonium sulfate based on a total amount of 30.0 g. Other values are shown in Table 4.

TABLE 4

| | | | | | | | | | | Comp. | |
|---|---|---|---|---|---|---|---|---|---|---|---|
| | | Example 13 | | Example 14 | | Example 15 | | Example 16 | | Ex. 4 | |
| Temperature | Te | 25° C. | | 25° C. | | 25° C. | | 40° C. | | 25° C. | |
| | Tk | 30° C. | | 30° C. | | 30° C. | | 40° C. | | 25° C. | |
| | Ts | 20° C. | | 15° C. | | 22° C. | | 37° C. | | 30° C. | |
| | Te − Ts | 5° C. | | 10° C. | | 3° C. | | 3° C. | | −10° C. | |
| | Tk − Ts | 10° C. | | 15° C. | | 8° C. | | 3° C. | | −10° C. | |
| Cloud point | Flow f | <0° C. | | <0° C. | | <0° C. | | <0° C. | | <0 ° C. | |
| | Flow k | 145° C. | | 145° C. | | 145° C. | | 145° C. | | 145° C. | |
| | Flow h | 109° C. | | 108° C. | | 110° C. | | 111° C. | | 117° C. | |
| Composition | Flow | k | h | k | h | k | h | k | h | k | h |
| | Total | 30.0 | 35.2 | 30.0 | 35.3 | 30.0 | 35.0 | 30.0 | 34.3 | 30.0 | 31.8 |
| | amount. (g) | | | | | | | | | | |
| | Water (g) | 9.0 | 14.2 | 9.0 | 14.3 | 9.0 | 14.0 | 9.0 | 13.3 | 9.0 | 10.8 |
| | Polymer (g) | 21.0 | 21.0 | 21.0 | 21.0 | 21.0 | 21.0 | 21.0 | 21.0 | 21.0 | 21.0 |

| | | | | | |
|---|---|---|---|---|---|
| Water migration | 5.2 | 5.3 | 5 | 4.3 | 1.8 |
| from e to h (g) | | | | | |

According to the aforementioned embodiments, setting the temperature Tf of the flow f or the temperature Ts within the counter flow extraction device S to be lower than the temperature Tk of the thermal phase change polymer stream k and the temperature Te of the flow e was shown to be advantageous in terms of the amount of migrated water.

However, cooling energy, heating energy and motive power energy are required to actually operate the system of the present invention. An investigation was therefore made in the following examples of the relationship between the total amount of energy consumed by the system and the amount of purified water.

### Examples 17 and 18

The following indicates the results obtained by simulating the total amount of energy consumed by the system per unit amount of purified water when water was purified using the system of the present invention.

Table 5 indicates the results of Example 17 that was carried out using the system of FIG. 1, while Table 6 indicates the results of Example 18 that was carried out using the system of FIG. 2.

TABLE 5

| | Example 17 (System of FIG. 1) | | | | |
|---|---|---|---|---|---|
| Tk (° C.) | 41.0 | 39.0 | 37.4 | 35.0 | 32.0 |
| Tf (° C.) | 41.0 | 38.0 | 35.0 | 30.0 | 22.0 |
| Tk − Tf (° C.) | 0.0 | 1.0 | 2.4 | 5.0 | 10.0 |
| Total amount of | 0.37 | 0.32 | 0.31 | 0.33 | 0.37 |
| energy consume | | | | | |
| per 1 t of purified | | | | | |
| water (kWh/t) | | | | | |

TABLE 6

| | Example 18 (System of FIG. 2) | | | | |
|---|---|---|---|---|---|
| Tk (° C.) | 42.0 | 39.0 | 36.5 | 34.0 | 30.0 |
| Ts (° C.) | 42.0 | 38.0 | 33.0 | 29.0 | 20.6 |
| Tk − Ts (° C.) | 0.0 | 1.0 | 3.5 | 5.0 | 9.4 |
| Total amount of | 0.35 | 0.30 | 0.27 | 0.28 | 0.36 |
| energy consume | | | | | |
| per 1 t of purified | | | | | |
| water (kWh/t) | | | | | |

### INDUSTRIAL APPLICABILITY

The system and method of the present invention can be preferably used in fields targeted at the recovery of solvent from inorganic and organic solutions. More specifically, the system and method of the present invention can be preferably used in fields such as the desalination of seawater, regeneration of domestic wastewater, regeneration of industrial wastewater or recovery of produced water discharged accompanying excavation of oil fields and gas fields.

1. A solvent separation system, comprising:
a first step for causing a feed stream a containing a solute and a solvent b to flow counter or parallel to an osmotic agent stream d through a semipermeable membrane o and causing the solvent b contained in the feed stream a to pass through the semipermeable membrane o and migrate into the osmotic agent stream d to obtain a flow e,
a second step for mixing the flow e containing the solvent b and the osmotic agent stream d with a thermal phase change polymer stream k to obtain a flow f, followed by separating the flow f containing the solvent b, the osmotic agent stream d and the thermal phase change polymer stream k into the osmotic agent stream d and a flow h containing the solvent b and the thermal phase change polymer stream k, and
a third step for heating the flow h followed by separating into the solvent b and the thermal phase change polymer stream k; wherein,
the second step simultaneously satisfies the following conditions (1) and (2):
(1) the relationship between a temperature Tk of the thermal phase change polymer stream k prior to mixing and a temperature Tf of the flow f after mixing is such that Tk−Tf=0.1° C. to 80° C., and
(2) the temperature Tf of the flow f after mixing is equal to or higher than the cloud point of the flow f.

2. The system according to claim 1, wherein the relationship between a temperature Te of the flow e prior to mixing and the temperature Tf of the flow f after mixing is such that Te−Tf=0.1° C. to 80° C.

3. The system according to claim 1, wherein the solvent b is water.

4. The system according to claim 1, wherein the thermal phase change polymer contained in the thermal phase change polymer stream k is a copolymer of ethylene oxide and propylene oxide, and the ends thereof are either hydroxyl groups or one or more of the end hydroxyl groups is substituted with one or more types of groups selected from the group consisting of an alkyl group, phenyl group, allyl group and aryl group.

5. The system according to claim 1, wherein the flow h containing the solvent b and the thermal phase change polymer stream k has a cloud point between 50° C. to 200° C.

6. The system according to claim 1, wherein the osmotic agent contained in the osmotic agent stream d is one or more types selected from the group consisting of an inorganic base, organic base, salt, ionic polymer, ionic liquid, nonionic polymer and organic compound.

7. The system according to claim 1, wherein the first step is carried out by a forward osmosis process.

8. A solvent separation method, comprising: separating a solvent b from a feed stream a containing the solvent b and a solute selected from an inorganic compound and an organic compound using the system according to claim 1.

9. A solvent separation system, comprising:
a first step for causing a feed stream a containing a solute and a solvent b to flow counter or parallel to an osmotic agent stream d through a semipermeable membrane o and causing the solvent b contained in the feed stream a to pass through the semipermeable membrane o and migrate into the osmotic agent stream d to obtain a flow e,
a second step for introducing the flow e, containing the solvent b and the osmotic agent stream d, and a thermal phase change polymer stream k into a counter flow extraction device S to cause the solvent b to migrate from the flow e into the thermal phase change polymer stream k followed by separating into the osmotic agent stream d and a flow h containing the solvent b and the thermal phase change polymer stream k, and
a third step for heating the flow h followed by separating into the solvent b and the thermal phase change polymer stream k.

10. The system according to claim 9, wherein the relationship between a temperature Tk of the thermal phase change polymer stream k prior to mixing and a temperature Ts within the counter flow extraction device S in the second step is such that Tk−Ts=0.1° C. to 80° C.

11. The system according to claim 9, wherein the relationship between a temperature Te of the flow e prior to mixing and the temperature Ts within the counter flow extraction device S in the second step is such that Te−Ts=0.1° C. to 80° C.

12. The system according to claim 9, wherein the solvent b is water.

13. The system according to claim 9, wherein the thermal phase change polymer contained in the thermal phase change polymer stream k is a copolymer of ethylene oxide and propylene oxide, and the ends thereof are either hydroxyl groups or one or more of the end hydroxyl groups is substituted with one or more types of groups selected from the group consisting of an alkyl group, phenyl group, allyl group and aryl group.

14. The system according to claim 9, wherein the flow h containing the solvent b and the thermal phase change polymer stream k has a cloud point between 50° C. to 200° C.

15. The system according to claim 9, wherein the osmotic agent contained in the osmotic agent stream d is one or more types selected from the group consisting of an inorganic base, organic base, salt, ionic polymer, ionic liquid, nonionic polymer and organic compound.

16. The system according to claim 9, wherein the first step is carried out by a forward osmosis process.

17. A solvent separation method, comprising: separating a solvent b from a feed stream a containing the solvent b and a solute selected from an inorganic compound and an organic compound using the system according to claim 9.

18. A solvent separation device, provided with:
a unit A that has a structure in which a feed stream a and an osmotic agent stream d flow through a semipermeable membrane o in the form of counter flow or parallel flow, and has an inlet port for the feed stream a, a discharge port for a flow c obtained after the feed stream a has flown counter or parallel to the osmotic agent stream d through the semipermeable membrane o, an inlet port for the osmotic agent stream d, and a discharge port for a flow e obtained after the osmotic agent stream d has flown counter or parallel to the feed stream a through the semipermeable membrane o,
a counter flow extraction device S that has a structure in which the flow e is caused to flow counter to the thermal phase change polymer stream k and the solvent b in the flow e is extracted into the thermal phase change polymer stream k to obtain a flow h, and has an inlet port for the flow e and a discharge port for the flow e following extraction, an inlet port for the thermal phase change polymer stream k, a discharge port for the flow h, and a temperature control function, and
a unit B that has a heat exchanger q2 for heating the flow h and a separator B, wherein the separator B has a function that separates the flow h into the thermal phase change polymer stream k and the solvent b, and the separator B has an inlet port for the flow h, a discharge port for the thermal phase change polymer stream k, and a discharge port for the solvent b.
